(19) United States
(12) Patent Application Publication
(10) Pub. No.: US 2014/0344847 A1
(43) Pub. Date: Nov. 20, 2014

(54) SYSTEM AND METHOD FOR MULTI-CHANNEL VIDEO STREAMING

(71) Applicant: Mobilitie, LLC, Bewport Beach, CA (US)

(72) Inventors: Gary B. Jabara, Irvine, CA (US); Lloyd Frederick Linder, Agoura Hills, CA (US); David Brett Simon, Agoura Hills, CA (US)

(21) Appl. No.: 14/455,559

(22) Filed: Aug. 8, 2014

Related U.S. Application Data
(63) Continuation-in-part of application No. 13/944,670, filed on Jul. 17, 2013.
Application No. 13/944,670 is a continuation-in-part of application No. 13/925,328, filed on Jun. 24, 2013.
Application No. 13/925,328 is a continuation-in-part of application No. 13/834,359, filed on Mar. 15, 2013.
Application No. 13/834,359 is a continuation-in-part of application No. 13/363,943, filed on Feb. 1, 2012.
Application No. 13/363,943 is a continuation-in-part of application No. 13/093,998, filed on Apr. 26, 2011.
Application No. 13/093,998 is a continuation-in-part of application No. 12/958,296, filed on Dec. 1, 2010.
Application No. 12/958,296 is a continuation-in-part of application No. 12/616,958, filed on Nov. 12, 2009, now Pat. No. 8,190,119.
Application No. 12/616,958 is a continuation-in-part of application No. 12/397,225, filed on Mar. 3, 2009, now Pat. No. 7,970,351.

(51) Int. Cl. H04N 21/2225; H04N 21/81; H04N 21/222; H04N 21/61; H04N 21/2365; H04N 21/258

(52) U.S. Cl. CPC H04N 21/2225; H04N 21/2365; H04N 21/25816; H04N 21/2223; H04N 21/6131; H04N 21/812
USPC 725/25; 725/81

(57) ABSTRACT

A video or multimedia distribution system receives multiple video streams and transcodes them into a single stream of video data packets with each of the video data packets for respective ones of the video streams being assigned a port number corresponding to the respective video stream. The video data packets are routed onto a network, such as the Internet, for delivery to remote viewers. In an exemplary embodiment, the remote viewers may be charged an access fee to receive the channels. A remote receiver decodes data packets with one or more of the port numbers to thereby receive selected ones of the original video streams.

### RELATED APPLICATIONS

This application is a continuation-in-part of U.S. application Ser. No. 13/944,670 filed on Jul. 17, 2013, which is a continuation-in-part of U.S. application Ser. No. 13/925,328 filed on Jun. 24, 2013, which is a continuation-in-part of U.S. application Ser. No. 13/834,359 filed on Mar. 15, 2013, which is a continuation-in-part of U.S. application Ser. No. 13/363,943 filed on Feb. 1, 2012, which is a continuation-in-part of U.S. application Ser. No. 13/093,998 filed on Apr. 26, 2011, which is a continuation-in-part of U.S. application Ser. No. 12/958,296 filed on Dec. 1, 2010, which is a continuation-in-part of U.S. application Ser. No. 12/616,958 filed on Nov. 12, 2009, now U.S. Pat. No. 8,190,119, which is a continuation-in-part of U.S. application Ser. No. 12/397,225 filed on Mar. 3, 2009, now U.S. Pat. No. 7,970,351, the entire disclosures and content of which are hereby incorporated by reference in their entirety.

### BACKGROUND OF THE INVENTION

1. Field of the Invention

The present invention is directed generally to wireless communication devices and, more particularly, to a system and method of video streaming of multiple video channels using wireless communication devices.

2. Description of the Related Art

Wireless communication networks have become commonplace. A vast array of base stations is provided by a wireless service provider to form a public mobile land network (PLMN). A number of known PLMNs are provided by different service providers and may or may not be compatible with each other depending on the particular implementation of the network. Wireless communication devices, such as cell phones, personal communication system (PCS) devices, personal digital assistant (PDA) devices, and web-enabled wireless devices communicate with the various base stations using one or more known communication protocols. While early cell phone devices were limited to analog operation and voice-only communication, modern wireless devices use digital signal protocols and have sufficient bandwidth to enable the transfer of voice signals, image data, and even video streaming. In addition, web-enabled devices provide network access, such as Internet access.

In a typical situation, the individual wireless communication devices communicate with one or more base stations. Even when two wireless communication devices are located a few feet from each other, there is no direct communication between the wireless devices. That is, the wireless devices communicate with each other via one or more base stations and other elements of the respective PLMNs of the two wireless communication devices.

Conventional personal computers (PC) typically include one or more wireless interfaces, such as Bluetooth and WiFi, to permit the easy connection of external devices to the PC (using Bluetooth, for example) or to simplify the implementation of a home network with wireless routers (using WiFi, for example) that establish a communication link between the PC and the router to thereby provide network access. The same WiFi connections are often used on laptop PCs to gain network access (e.g., the Internet) in hotels, airports, coffee shops, and the like. As is known in the art, the user must search for an available wireless network and select one of the available networks for connection thereto. Sometimes, a password and encryption are required to connect to the selected network.

State of the art mobile communication devices typically include a network transceiver to communicate with the service provider PLMN, as described above, and one or more short-range transceivers, such as Bluetooth and WiFi. The Bluetooth transceiver is often used to establish a connection with an automobile sound system to facilitate hands-free communication with the service provider PLMN using the network transceiver. The WiFi interface in the mobile communication devices can be used to provide network access (e.g., the Internet) in the same manner described above with respect to PCs and laptop computers. That is, the user must search for an available wireless network and select one of the available networks for connection thereto.

A new family of computing devices, such as tablet computers and electronic readers, have wireless communication capability as well. In some cases, the computing devices include both network transceivers and short-range transceivers, such as those described above. As can be appreciated, the PLMN implementation typically requires a contract with a service provider. In some tablet computers and electronic readers, the network transceiver has been eliminated, thus eliminating the need for a service provider contract, but also eliminating the ability to communicate via the service provider PLMN. With this type of device, network access is available only through a short-range transceiver that communicates with an access point (AP), such as may be found in hotels, airports, coffee shops, and the like. The APs are typically implemented as wireless access points and the portable computing device must connect to the AP in the same manner described above with respect to PCs and laptop computers. That is, the user must search for an available wireless network and select one of the available networks for connection thereto.

A popular use for network access is to download video or multimedia data. As can be appreciated by those skilled in the art, a request or demand for multimedia data requires a significant amount of bandwidth. In a public setting, such as an airport, simultaneous or overlapping requests for on-demand video will cause a slow down in the delivery of data to all devices connected to the particular AP.

Therefore, it can be appreciated that there is a need for the delivery of streaming video from APs to wireless communication devices in an effective manner without causing a slow down at the AP. The present invention provides this, and other advantages, as will be apparent from the following detailed description and accompanying figures.

### BRIEF DESCRIPTION OF THE SEVERAL VIEWS OF THE DRAWING(S)

FIG. 1 is an example of network architecture of a dynamic network illustrating communication between user equipment and wireless access points.

FIG. 2 is a functional block diagram of a television tuner system to provide multiple television signals to the video server of FIG. 1.

FIG. 3 is a functional block diagram of an integrated wireless access point and video server.

FIG. 4 is a functional block diagram of a remote video server operating in conjunction with a local video server.

FIG. 5 is functional block diagram of one of the wireless communication devices of FIG. 1.

FIGS. 6-8 illustrate different video display configurations for a mobile communication device.

FIG. 9 illustrates a venue with a large number of distributed wireless access points.

FIG. 10 illustrates a system architecture in which a venue communicates with a Cloud network.

FIG. 11 illustrates the Cloud network of FIG. 10 communicating with multiple venues.

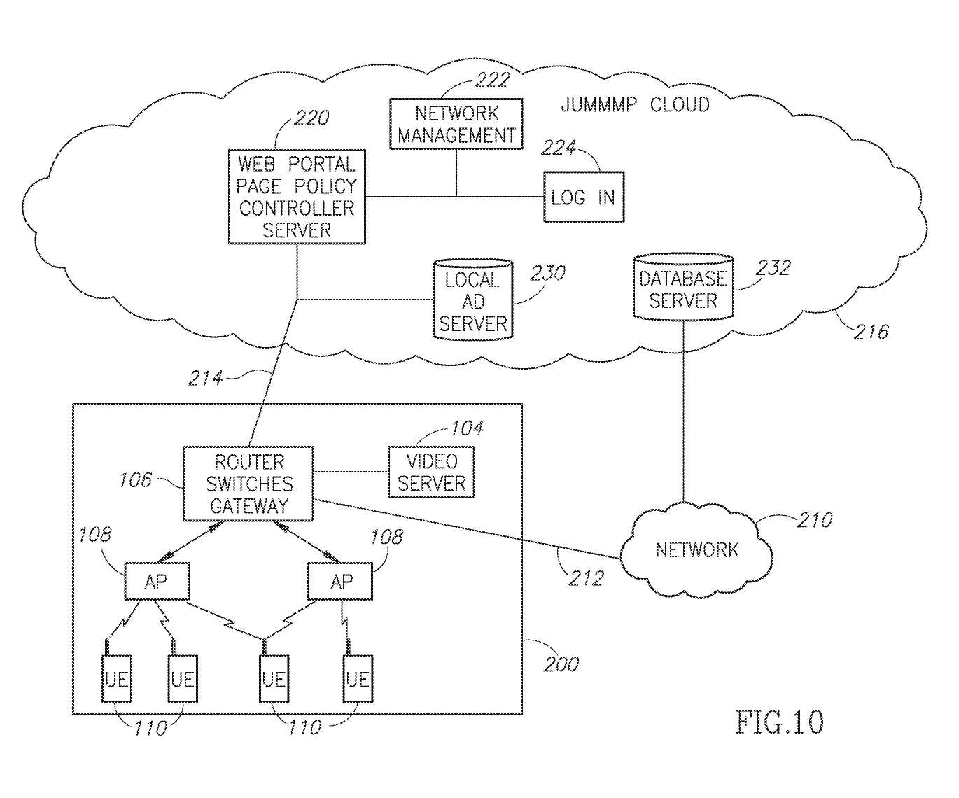

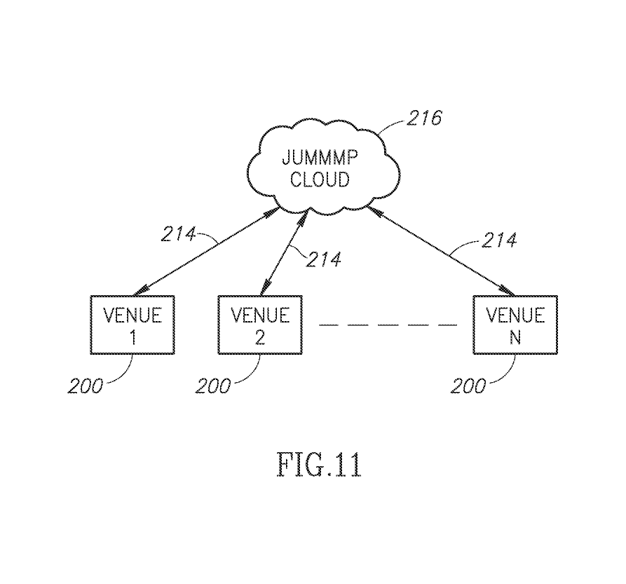

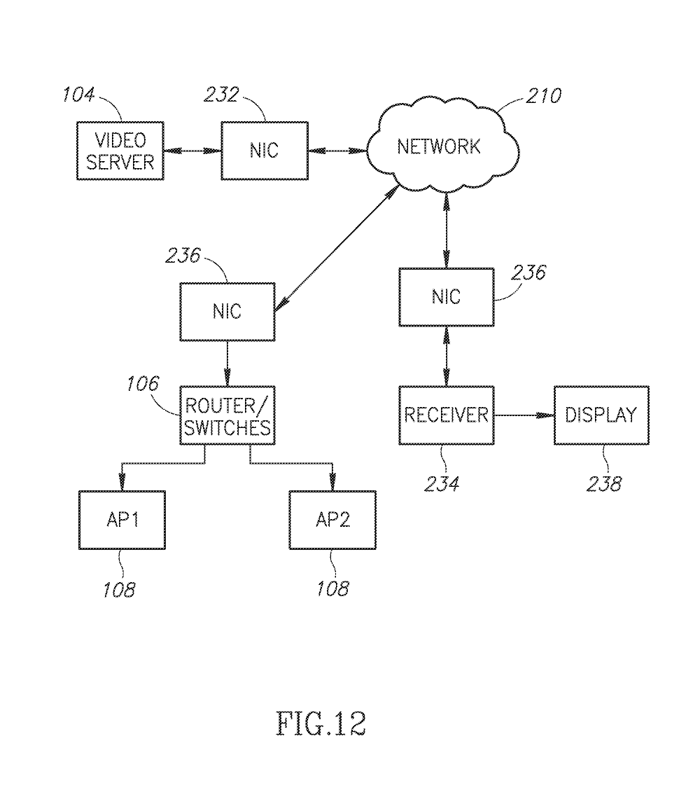

FIG. 10 illustrates a large array of wireless access points distributed throughout a sports venue.

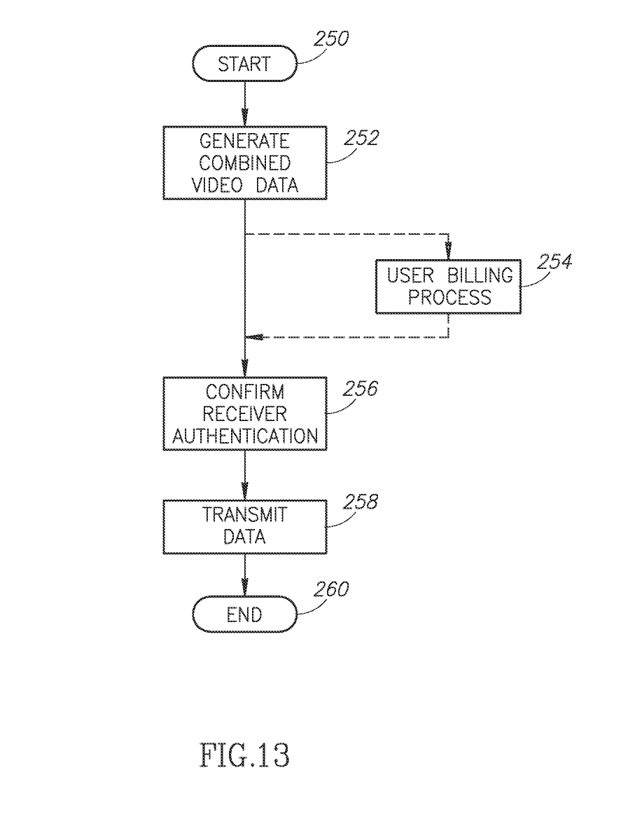

FIG. 11 illustrates an array of wireless access points distributed throughout a concert venue.

FIG. 12 is an example of network architecture to provide communication from a venue to user equipment at a remote location.

FIG. 13 is a flow chart describing an exemplary implementation of the system of FIG. 12.

### DETAILED DESCRIPTION OF THE INVENTION

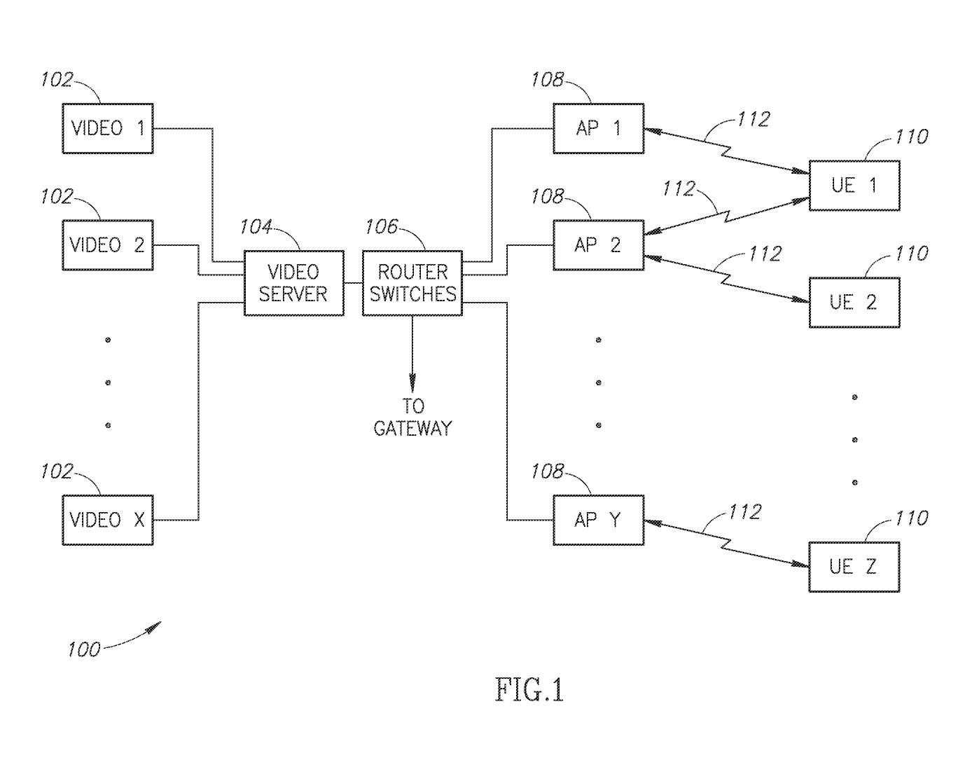

The system described herein permits the distribution of a multiple video channels through one or more wireless access points for reception by a plurality of wireless communication devices. FIG. 1 illustrates a system 100 that illustrates an exemplary embodiment of the video distribution system. In the system 100, a plurality of video sources 102 are illustrated in FIG. 1 as VIDEO 1, VIDEO 2, . . . VIDEO X. The video sources 102 may be live video, such as produced by a video camera, or may be remote video feeds, such as provided by a television network. Then video feed could also be an instant replay channel under control of a server.

A video server 104 is configured to receive the individual video streams from the video sources 102. The video server 104 is implemented by one or more conventional computing devices. The general operation of a server is well known in the art and need not be described herein except as related to the specific video processing.

The video server 104 processes the multiple individual video streams and creates a single stream of video data packets. In an exemplary embodiment, the video server 104 creates a single stream of video data packet in accordance with a User Datagram Protocol (UDP), which is a conventional Internet communication protocol. As is known in the art, UDP is a simple transmission protocol with no handshaking and no integrated error correction capabilities. On the other hand, UDP is useful in time-sensitive applications where the error correction capabilities provided by other protocols, such as TCP, are undesirable.

The UDP protocol also provides for port numbers to be included in each UDP data packet. In accordance with the present disclosure, the video server 104 creates video data packets for each of the video streams from the video sources 102 but assigns a different port number for each of the respective video sources. For example, VIDEO 1 will be packetized into a plurality of UDP packets where each of the packets corresponding to the VIDEO 1 stream has the same port number. In contrast, the VIDEO 2 is encoded into a plurality of UDP data packets, but uses a different port number than the VIDEO 1 data stream. Thus, the video server 104 encodes each video stream and adds them into a single stream of UDP packets where the UDP packets corresponding to each video stream are assigned different port numbers.

In this manner, the video server 104 creates a single stream of UDP packets where the individual packets have different port numbers that correspond to the video streams from the respective video sources 102. The stream of UDP packets are routed through an infrastructure 106 to a plurality of wireless access points (APs) 108. The particular form of the infrastructure 102 depends on the specific implementation of the system 100. However, the infrastructure 106 typically includes routers, switches, and may include a gateway, as will be discussed later. The function of the infrastructure 106 is to route the UDP video packets from the video server 104 to one or more of the APs 108. In addition, the infrastructure 106 routes data from the APs 108 to the video server 104.

In FIG. 1, the APs 108 are illustrated as AP 1, AP 2, . . . AP Y. In an exemplary embodiment, the UDP video data packets are routed to all the APs 108 such that each AP receives the same video data packets. In an alternative embodiment, the data packets for different video sources can be routed to selected ones of the APs 108. For example, all UDP packets with a port number corresponding to the VIDEO 1 data stream can be routed only to AP 1 and AP 2. In contrast, the UDP data packets with a port number corresponding to the VIDEO 2 stream can be routed to all APs 108. Thus, the system 100 has the ability to selectively route the UDP video packets to one or more of the APs 108 under control of the video server 104. In addition, the APs 108 must be configured to broadcast UDP data frames and not block the broadcast of any UDP data frames.

FIG. 1 also illustrates a plurality of wireless communication devices, sometimes referred to as user equipment (UE) 110. The term UE is intended to include any wireless communication device capable of processing audio, video, and text messaging. This includes smart phones, laptops, PDAs, computer tablets (e.g., an iPad™), and the like. These devices may or may not include a network transceiver for communication with a public land mobile network (PLMN). The system 100 is not limited by the particular form of the communication device.

In FIG. 1, the UEs 110 are illustrated as UE1, UE2, . . . UE Z. As will be described in greater detail below, the UEs 110 include programming that allows the individual UEs 110 to selectively receive UDP data packets having a single selectable port number. Thus, each UE 110 can select a particular video stream for viewing on a display of the UE 110 by selecting the port number corresponding to the desired video stream. If the UE 110 has sufficient computing power, it may select more than one port number to thereby receive and process multiple video streams. For example, the UE 110 may select two port numbers and display two video screens in a side-by-side fashion much like split-screen television. In yet another embodiment, the UE 110 may select multiple port numbers and display multiple video streams with a reduced screen size. For example, the UE may display a plurality of video signals as thumbnail (or larger) video signals simultaneously on the display.

The UEs 110 may be able to establish a communication link with more than one AP 108. As illustrated in FIG. 1, UE 1 can communicate with both the AP 1 and AP 2 via respective wireless communication links 112. FIG. 1 illustrates UE 2 as coupled only to the AP 2 via wireless communication link 112 while UE Z communicates with AP Y via wireless communication link 112. Thus, the UEs 110 are in wireless communication with one or more of the APs 108.

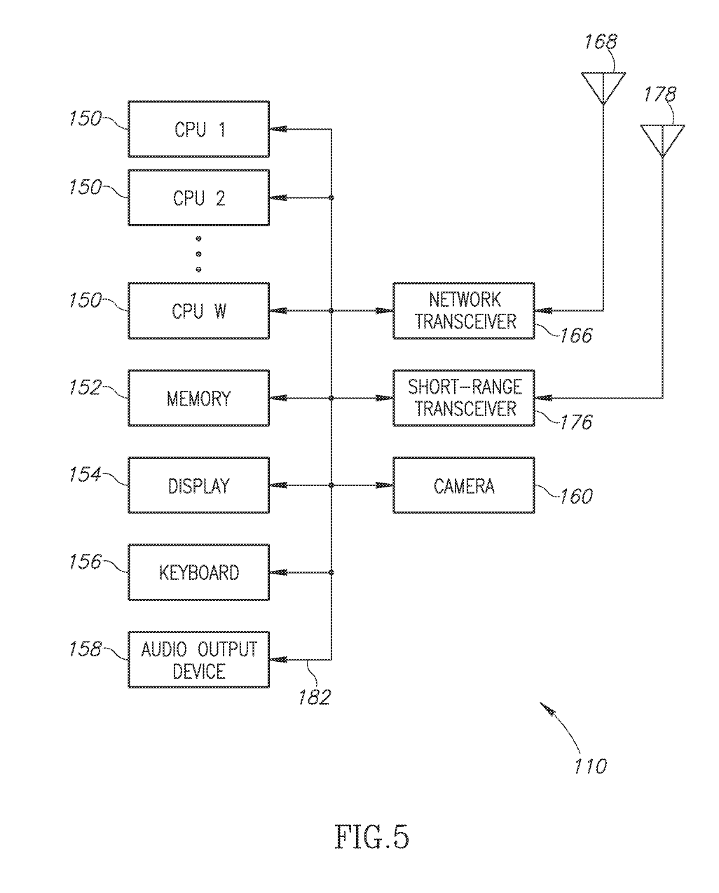

Those skilled in the art will appreciate that the APs 108 are transmitting multiple video channels to any UE 110 within range of an AP. This multi-channel approach is in contrast to conventional unicast streaming. In unicast streaming, the AP 108 receives a data stream for each individual UE 110. The requirement of one video stream for each end user will quickly consume all of the available bandwidth for the AP. In contrast, the transmission of a single data stream for UDP broadcast or multicast in accordance with the system 100 described herein makes video streams available for an unlimited number of UEs 110 that may be connected to an AP 108. The approach overcomes the bandwidth limitations of unicast streaming. In addition, as will be described in greater detail below, the application associated with the UDP streaming functions as an equivalent to a TV guide for watching different channels or video streams broadcast from the AP 108. A display on the UE 110 can be dynamically configured by the video server 104. In addition to the video streams, the video server 104 can also send out a list of channels that are being provided via the APs 108. Alternatively, as will be discussed in greater detail below, the TV guide data may be in the form of text, graphical display data, still images, such as a captured video frame, or an actual display of multiple video signals. For example, the UE 104 can display multiple thumbnail (or larger) video signals corresponding to each of the available channels. Thus, the number of video streams from different video sources 102 is limited by the bandwidth capacity of a particular AP 108. As APs 108 use improved technology, the number of video sources 102 available for streaming can also increase accordingly. However, the number of available video streams is not generally limited by the number of UEs 110 receiving data from any particular AP 108. That is, the number of UEs 110 receiving data from a particular AP 108 is almost unlimited. Thus, the number of UEs 110 viewing video streams is effectively detached from the bandwidth limitation of the AP 108 itself. The system 100 permits the equivalent of broadcast television on the display 154 (see FIG. 5) as opposed to a classical television screen.

In operation, the video server 104 can receive the various video streams from the video sources 102 in different formats. However, those skilled in the art will appreciate that certain formats may simplify the process of transcoding from multiple video streams to the UDP video packets. In an exemplary embodiment, the video data is formatted in accordance with MPEG-2. If the data is multimedia data, the audio data is also formatted in accordance with MPEG standards. If the video sources 102 provide video in the MPEG-2 video format, the video server 104 need not perform any conversion. Furthermore, there are other optimization settings that are imposed by the video server 104, or more may already be provided by the video sources 102. For example, a video frame rate of 24-30 frames per second provides a relatively smooth video display on the UE 110. In another example of optimization settings, the video server 104 may provide the video data at a rate of 64,000 bits per second (bps) to 300,000 bps. The audio signal may be sampled at approximately 32,000 bps. A video size of 320 pixels by 240 pixels or smaller is generally satisfactory for the typical display 154 (see FIG. 5) on the UE 110. As noted above, the video sources 102 may already provide the data in this format. If the video sources 102 provide video data as an analog signal, the video server 104 must process the data accordingly.

In an exemplary embodiment, the video server 104 utilizes MPEG-TS, which refers to a conventional encoding process for a transport stream. The video server 104 provides UDP streaming and uses a UDP broadcast address or a UDP multicast address that is computed using the net mask and IP address. The UEs 110 connect to one or more APs 108 in a conventional manner. The API or software application executing on each UE 110 monitors the broadcast or multicast address and a selected port. Current APs 108 may be configured for operation in accordance with IEEE 802.11n. These devices are dual-band (i.e., 2.4 GHz and 5 GHz). In addition, many access points are designed for operation with multiple input-multiple output (MIMO) antenna configurations. Under ideal conditions, such dual-band APs 108 can generally support 10 or more video streams with each video stream requiring approximately 1 megabit per second (Mbps). Those skilled in the art will appreciate that the distance between the AP 108 and the UE 110 is a significant factor for data throughput rates. However, in a typical venue 200, such as described herein, a large number of APs 108 can be positioned to provide a high quality signal level to the UE 110.

There are presently some mobile communication devices, such as a Windows8™ product, that does not include UDP processing capability. To provide communications with these devices, the system 100 can apportion the available bandwidth of one or more of the APs 108 to permit the simultaneous broadcast of both broadcast/multicast data and unicast data. One portion of the AP bandwidth is allocated for use with TCP/IP and another portion of the AP bandwidth is allocated for the UDP broadcast/multicast.

To accommodate the apportionment of available AP bandwidth, the network 210 (see FIG. 10) can adjust the up/down data rates to conserve bandwidth. The data rate can be throttled to permit both unicast and broadcast/multicast transmissions from a single AP 108.

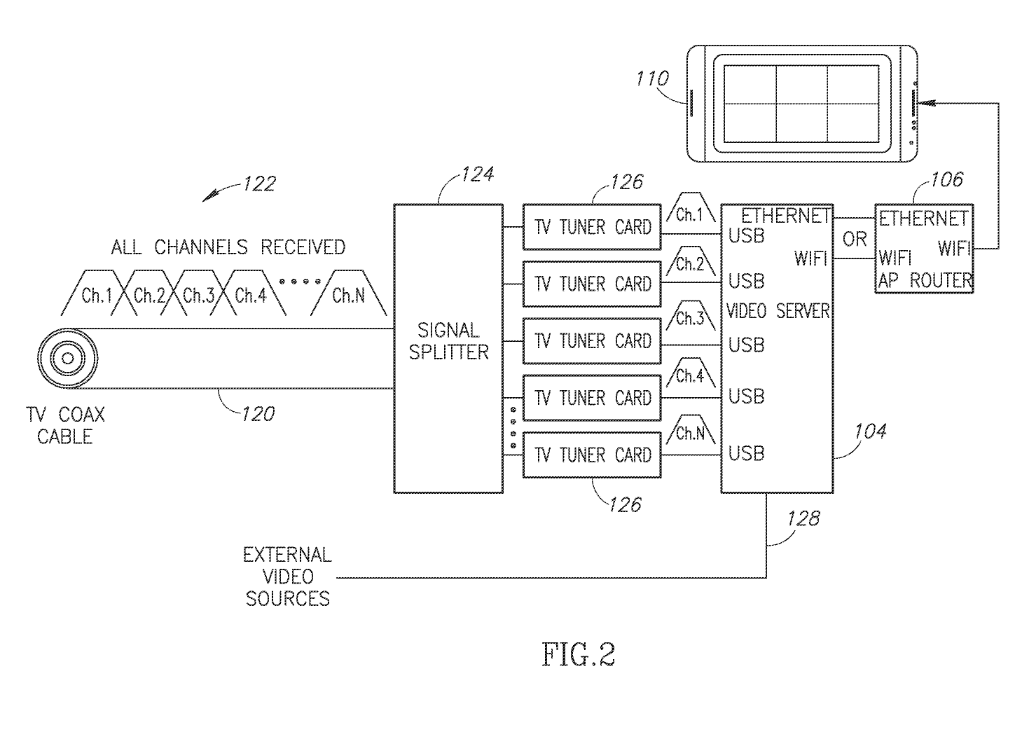

FIG. 2 is a functional block diagram of a tuner system to permit the reception and encoding of multiple television channels. FIG. 2 illustrates a coaxial cable, such as may be used to provide television signals from a cable source, a satellite source, or the like. As those skilled in the art will appreciate, the cable 120 will carry multiple channels indicated by a reference 122 that shows multiple channels labeled Ch. 1-Ch. N. The cable 120 is cabled to a signal splitter 124, which may also include a conventional amplifier. The multiple outputs of the signal splitter 124 are coupled to inputs of individual TV tuner cards 126. Although each TV tuner card 126 is illustrated as a separate circuit in FIG. 2, some circuit boards may include multiple TV tuner cards. The TV tuner cards 126 are commercial products that tune the individual channels (i.e., Channels 1-N). In an exemplary embodiment, the output of each TV tuner card 126 is a digital signal. In an exemplary embodiment, the audio and video signals may be generated by the TV tuner card 126 in accordance with known industry standards, such as MPEG 2 and MPEG 4. As is known in the art, MPEG 2 is a standard for coding of moving pictures and associated audio data. The MPEG 4 standard defines compression for audio and video digital data.

The outputs of the individual TV tuner cards 126 are coupled to corresponding inputs on the video server 104. In the embodiment illustrated in FIG. 2, the TV tuner cards 126 are implemented with a universal serial bus (USB) interface and are coupled to corresponding USB interfaces on the video server 104. Those skilled in the art will appreciate that other interfaces, such as an Ethernet interface, may also be satisfactorily employed. The system 100 is not limited by the type in interface connecting the TV tuner cards 126 with the video server 104.

In addition to the TV tuner cards 126, the video server may receive one or more external video sources 128. The external video sources may be video only or may include audio data to thereby form a multimedia data stream. The external video sources 128 are intended to represent one or more video sources. The external video sources 128 may be generated locally within a single venue, or delivered from a remote location via conventional means, such as satellite communication link, microwave, cable, or the like.

In operation, the video server 104 may include a media player, such as a VLC media player, that is configured to receive video signals in various formats, such as MPEG 2 and MPEG 4. The media player program reformats the data from each of the TV tuner cards 126 into a UDP format. The UDP data is then in a suitable format for streaming. The video server 104 assembles the individual UDP packets from the TV tuner cards 126 and any external video sources 128 and creates a single UDP stream. As discussed above, the UDP packets are provided with port numbers that correspond to the individual channels. That is, all of the UDP packets for Ch. 1 have the same port number. In addition, all of the UDP packets for Ch. 2 have the same port number, but a different number from that assigned to the packets for Ch. 1. Thus, each UDP packet may be identified as part of a stream from the individual TV tuner cards 126 based on the unique port numbers assigned thereto. Similarly, the external video sources 128 are assigned individual port numbers corresponding to the individual ones of the external video sources.

In an embodiment described herein, the single stream of UDP data packets is routed through the router switches 106 (see FIG. 1) to the various APs 108. In an alternative embodiment, the video server 104 may generate the serial UDP data stream using an Ethernet interface. In this embodiment, the streaming video signals are routed via conventional Ethernet interface and decoded in the same manner as data packets transmitted from the APs 108.

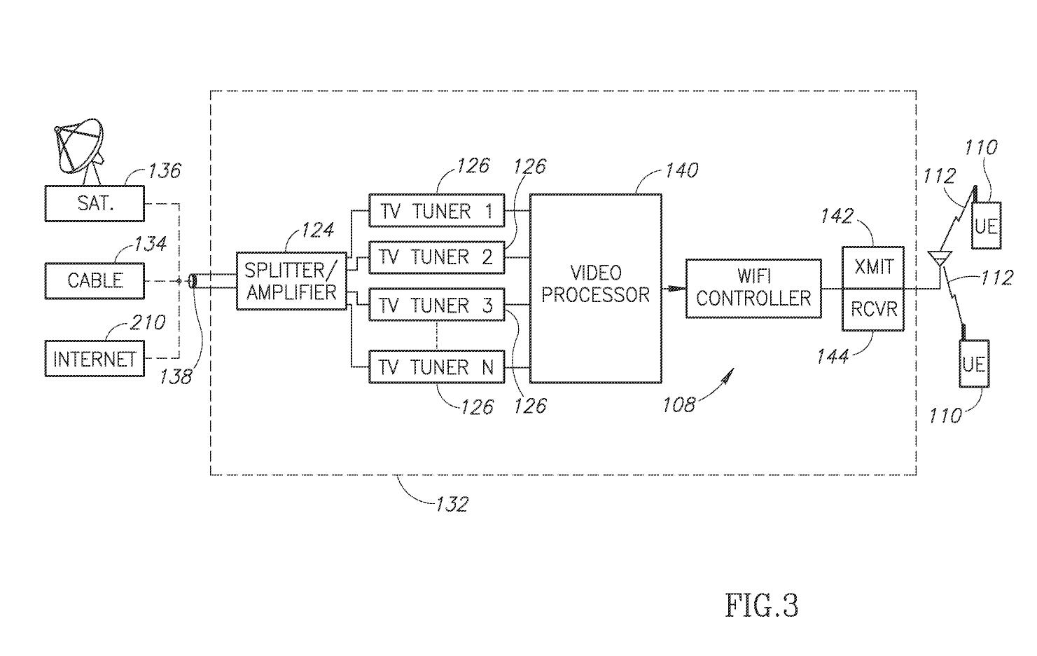

An integrated version 132 of the system of FIG. 2 is illustrated in FIG. 3. The device 132 in FIG. 3 is an integrated tuner and AP. The radio frequency (RF) television signals can be provided by a cable service provider 134, a satellite receiver 136, or the like. The RF signals are provided to an input connector 138, such as a cable connector. The splitter 124, which may also include a conventional amplifier, splits the single signal into multiple signals that are connected to the inputs of a plurality of TV tuner cards 126. As noted above, the TV tuner cards 126 may be implemented as individual cards or may be implemented with multiple tuners on a single card. For the integrated device 132, the TV tuner cards 126 may be integrated onto a single board. The outputs of the TV tuners 126 are couple to a processor 140, which provides the functionality of the video server 104. The processor 140 may be implemented as a conventional microprocessor, a graphics processor, a digital signal processor, programmable gate array, application specific integrated circuit, or the like. The integrated device 132 is not limited by the specific implementation of the processor 140.

The integrated device 132 does not require all the functionality of the video server 104 and only communicates with a single integrated AP 108 having a transmitter 142 and receiver 144. The single AP 108 functions in the manner described above with respect to the plurality of APs 108. The AP receiver 144 can receive communications from any of the UEs 110. In one embodiment, the UEs 108 can request a particular TV channel. If none of the TV tuners 126 are tuned to that channel, the processor 140 can send instructions to one of the plurality of TV tuners to change to the requested channel. Thereafter, the processor 140 will begin receiving the video stream from the user-requested channel and encode that channel in the manner described above. Thus, the integrated system 132 can provide multiple channels and change channels on user request. This is in addition to the multiple channels already provided by the UDP stream from the AP 108.

The integrated device 132 does not require the infrastructure 106 (see FIG. 1) because the processor 140 is connected directly to the AP 108. Thus, the processor 140 need only provide the functionality of transcoding the individual data streams from the TV tuners 126 and the generation of the single UDP output stream. As described above with the video server 104, the processor 140 will assign a port number to each UDP data packet that corresponds with a respective one of the plurality of data streams.

A power supply (not shown) makes the integrated device 132 as a self-contained device. The integrated device 132 has utility in a setting, such as a home where the integrated device 132 has an input 138, such as a cable input. The processor 140 encodes the plurality of video streams and broadcasts them throughout the home using the integrated AP 108. Conventional WiFi extenders (not shown) may be used to extend the range of the AP 108. Alternatively, a large home may include multiple ones of the integrated devices 132.

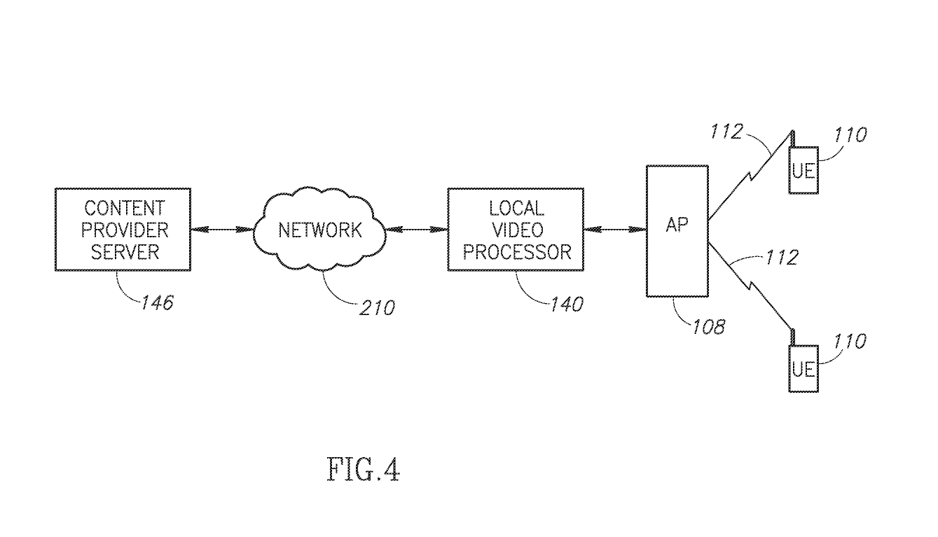

Another variation of the embodiment of FIG. 3 is illustrated in FIG. 4. In this embodiment, a content provider server 146 contains a plurality of data files, such as movies, available for on-demand delivery. The content provider server 146 is remote from and coupled to a local implementation of the video server 104 (see FIG. 1) or the processor 140 (see FIG. 3) via the network 210, such as the Internet. The local processor 140 receives on-demand requests from one or more of the UEs 110 via the AP 108. While FIG. 3 illustrates only one AP 108, the embodiment of FIG. 4 can include one or more APs 108 to provide coverage over a selected area.

The local processor 140 relays the on-demand requests to the content provider server 146. A unicast connection link is established between the content provider server 146 and the local processor 140. In an exemplary embodiment, the on-demand data streams are transmitted using conventional unicast protocols, such as TCP/IP. A device, such as the VLC media player discussed above, receives the unicast data stream and transcodes the data packets into a stream of data packets for transmission by the AP 108. In one embodiment, the transcoding process generates a single data stream in accordance with UDP protocols. As described above with respect to other implementations, the local processor 140 assigns a different port number to the UDP packets for each of the different received data streams. The processor 140 sends the single stream of UDP packets to the AP 108 for transmission in the manner described above. The AP 108 transmits the multicast data packets in the manner described above so that each UE 110 can receive any one or more of the desired data streams from the AP 108.

In an exemplary embodiment, the device of FIG. 4 could be used in a home or a hotel where the local processor 140 is configured to communicate with the content provider server 146 via a unicast Internet connection. The local processor 140 transcodes the received unicast data streams and may also receive data streams from other sources, such as the TV tuner cards 126 (see FIG. 2) and/or the external video sources 128 (see FIG. 2). The various sources are transcoded and turned into a single data stream for transmission by one or more APs 108.

In another example, the embodiments of FIGS. 3-4 can be implemented aboard a vehicle, including, but not limited to an automobile, bus, recreational vehicle, subway, train, aircraft, or the like. This process is described in U.S. patent application Ser. No. 13/944,670, filed on Jul. 17, 2013, the entire disclosure and content of which is incorporated herein by reference.

FIG. 5 is a functional block diagram illustrative of one of the UEs 110 illustrated in FIG. 1. The system 100 takes advantage of current implementations of the UE 110 that typically include multiple processors. As will be described in greater detail below, one processor in the UE is configured to handle communications with the AP 108 while a second processor is configured for playback of received video data. The UE 110 in FIG. 5 includes a plurality of central processing units (CPUs) 150. The CPUs 150 are illustrated in FIG. 5 as CPU 1, CPU 2, CPU W. Those skilled in the art will appreciate that the CPUs 150 may be implemented as conventional microprocessors, an application specific integrated circuit (ASIC), digital signal processor (DSP), programmable gate array (PGA), or the like. The UE 110 is not limited by the specific form of the CPUs 150.

The UE 110 in FIG. 5 also contains a memory 152. In general, the memory 152 stores instructions and data to control operation of the CPUs 150. The memory 152 may include random access memory, ready-only memory, programmable memory, flash memory, and the like. The UE 110 is not limited by any specific form of hardware used to implement the memory 152. The memory 152 may also be integrally formed in whole or in part with the CPUs 150.

The UE 110 of FIG. 5 also includes conventional components, such as a display 154, a keypad or keyboard 156, an audio output device 158, and camera 160. In many UEs 110, the display 154 is a touch-sensitive display that incorporates the functionality of the display 154 and the keyboard 156. These are conventional components that operate in a known manner and need not be described in greater detail. Other conventional components found in wireless communication devices, such as a USB interface, Bluetooth interface, infrared device, and the like, may also be included in the UE 110. For the sake of clarity, these conventional elements are not illustrated in the functional block diagram of FIG. 5.

In some embodiments, the UE 110 of FIG. 5 also includes a network transceiver 166 such as may be used by the UE 110 for the conventional wireless communication network with the service provider PLMN (not shown), as described above. The network transceiver 166 is connected to an antenna 168. The network transceiver 166 is illustrated as a generic transceiver. The UEs 110 may be implemented in accordance with any known wireless communication protocol including, but not limited to, CDMA, WCDMA, GSM, UMTS, 3G, 4G, WiMAX, LTE, or the like. Operation of the network transceiver 166 and the antenna 168 for communication with the PLMN (not shown) is well-known in the art and need not be described in greater detail herein.

The UE 110 of FIG. 5 also includes a short-range transceiver 176 that is used by the UEs 110 to communicate with the APs 108 of FIG. 1. The short-range transceiver 176 is connected to an antenna 178. In an exemplary embodiment, the antennas 168 and 178 may have common components are implemented as a single antenna.

The various components illustrated in FIG. 5 are coupled together by a bus system 180. The bus system may include an address bus, data bus, power bus, control bus, and the like. For the sake of convenience, the various busses in FIG. 5 are illustrated as the bus system 180.

In an exemplary embodiment, the short-range transceiver 176 may be designed for operation in accordance with IEEE standard 802.11, sometimes referred to as WiFi. Most modern wireless communication devices are equipped with WiFi and may be readily upgraded to support the functionality described herein. A technique for establishing communication between the UEs 110 and the APs 108 using WiFi is described in U.S. application Ser. No. 12/397,225, filed on Mar. 3, 2009, now U.S. Pat. No. 7,970,351. Because the UEs 108 all include WiFi capability, the UEs may be designed for communication with the APs 108, regardless of the type of service provider PLMN or, indeed, in the total absence of the network transceiver 166 (see FIG. 1). Thus, the UE 110 may operate under IEEE 802.11a at 5 gigahertz (GHz) under IEEE 802.11b/g at 2.4 GHz, or IEEE 802.11n, which operates at both 2.4 GHz and 5 GHz. Those skilled in the art will appreciate that the wireless communication device of the system 100 may be readily adapted for operation with future versions of IEEE 802.11.

Various techniques for establishing the short-range communication links 112 (see FIG. 1) are described in U.S. application Ser. No. 12/397,225 filed on Mar. 3, 2009, now U.S. Pat. No. 7,970,351, U.S. application Ser. No. 12/616,958 filed on Nov. 12, 2009, U.S. application Ser. No. 12/958,296, filed on Dec. 1, 2010, U.S. application Ser. No. 13/093,998 filed on Apr. 26, 2011, and U.S. application Ser. No. 13/363,943 filed on Feb. 1, 2012, the entire disclosures and content of which are hereby incorporated by reference in their entirety.

The user of a conventional wireless communication device can search for a wireless access point and connect to that access point, as is common in public areas, such as an airport terminal, coffee shop, or the like. The goal of this connection is generally to provide Internet access. However, the UEs 110 described herein can include an application program interface (API) that can be programmed into the UE at the time of manufacture or downloaded in a conventional manner. Some functionality of the API will be described herein. A more complete description of the API is provided by U.S. patent application Ser. No. 13/093,998 and titled System and Method for Management of a Dynamic Network Using Wireless Communication Devices, filed on Apr. 26, 2011 and incorporated herein by reference in its entirety. The API becomes part of the operating system in that it is always executing in the background. In this manner, the API is different from a conventional application software program that must be activated by the user. In one aspect, the API includes a “heartbeat” signal that periodically communicates with any available AP 108 and provides identification data, location data and the like to a database server 232 (see FIG. 10). In addition, the API advantageously simplifies authentication of the UE whenever it enters a venue that is part of the system described herein.

In FIG. 1, the UE 1 has established the wireless communication links 112 with the AP 1 and AP 2, respectively. As the user moves from one location to another in a particular venue, he may move in or out of range of one AP 108 or the other. Thus, the UE 110 can receive the video stream from one of the plurality of APs 108 distributed throughout the venue.

In operation, the API or a separate application program provides a set of instructions to two of the CPUs 150 to perform specific tasks. In an exemplary embodiment, a first processor (e.g., CPU 1) is programmed with native code to perform the task of capturing data packets received from the APs 108 and storing the received data packets. As used herein, the term “native code” refers to software code that has been compiled to processor-specific machine code. In the example described herein, CPU 1 is responsible for capturing all data packets that have a specified port number. The CPU 1 is programmed to provide the singular function of capturing UDP data packets having the designated port number and storing those captured data packets in the memory 152.

While the CPU 1 is programmed with native code to perform the function of capturing and storing UDP data packets, a second processor (e.g., the CPU 2) is also programmed with native code to perform the function of retrieving the stored data packets and playing them on the display 154. In addition, if the captured video stream is a multimedia stream, the CPU 2 also provides audio data to the audio output device 158.

In one embodiment, the CPU 1 receives and stores the UDP data packets for a short time and then closes the file in which the received data packets are stored. This permits a second processor, the CPU 2, to open the file and play back the stored data packets on the display 154. In this embodiment, the CPU 1 saves the received UDP data packets as a series of files that are closed after a short period of time while the CPU 2 opens the closed files and plays the received UDP packets on the display. If the received data packets are multimedia data packets, the CPU 2 also sends data to the audio output device 158.

In an alternative embodiment, the operation of the CPU 1 and CPU 2 is tightly integrated so that both the CPU 1 and the CPU 2 can access the same file in the memory 152. In this embodiment, there is only a single data file with the CPU 1 storing received data packets in the data file in the memory 152 while the CPU 2 retrieves and plays the data packets from the single data file in the memory 152 on the display 154 and the audio output device 158 if the video stream is a multimedia file.

The efficient native code programming of the CPU 1 and CPU 2 allows the UE 110 to effectively capture and play back a video data stream. In the UE 110, the CPU 1 is programmed for the singular function of capturing and storing UDP data packets while the CPU 2 is programmed for the singular function of retrieving and playing the stored UDP data packets. The tight operation of the CPU 1 and CPU 2 permit the effective capture and play of UDP data packets at an acceptable frame rate to effectively provide streaming video or streaming multimedia to the UE 110 from the APs 108 within a venue.

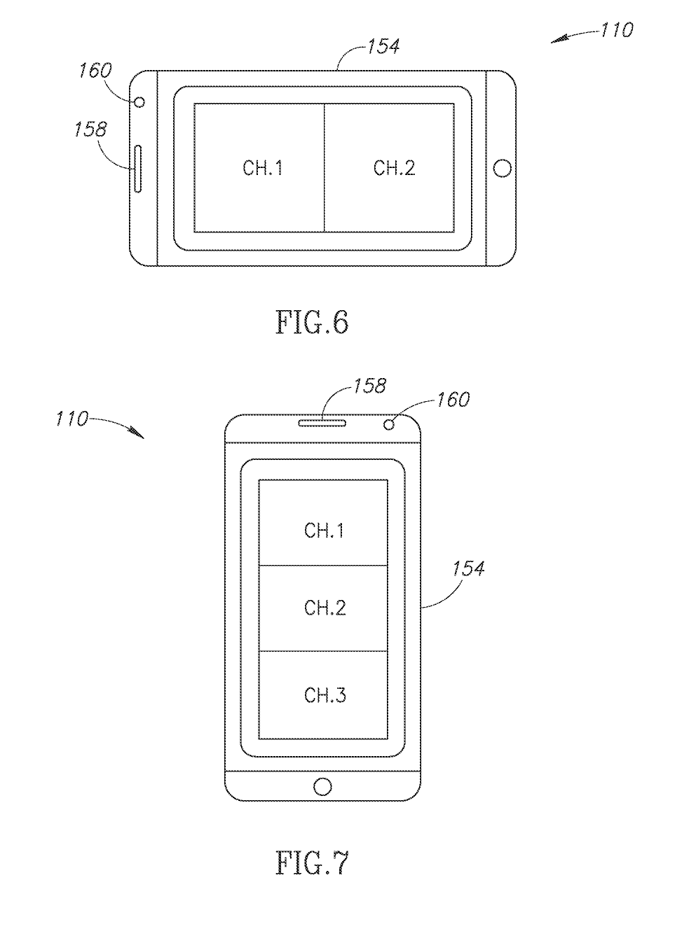

In an alternative embodiment, CPU 1 and CPU 2, or additional ones of the CPUs 150, can be programmed to receive and process UDP data packets with multiple different port numbers, thus enabling the UE 110 to receive multiple channels simultaneously. In this embodiment, the CPUs 150 may receive and decode multiple channels and show them side-by-side on the display 154 as illustrated in FIG. 6. Thus, the UE 110 may operate in a mode equivalent to split-screen television. The user can select which audio signal, if any, to process. While the UE 110 can process both audio signals, the simultaneous playing of two audio signals would create an unpleasant user experience.

In yet another embodiment, the UE 110 can process additional video signals by detecting additional port numbers in the UDP packets associated with the desired channels. For example, FIG. 7 illustrates three channels shown on the display 154. Again, the user can determine which audio signal to process for play out on the output device 158.

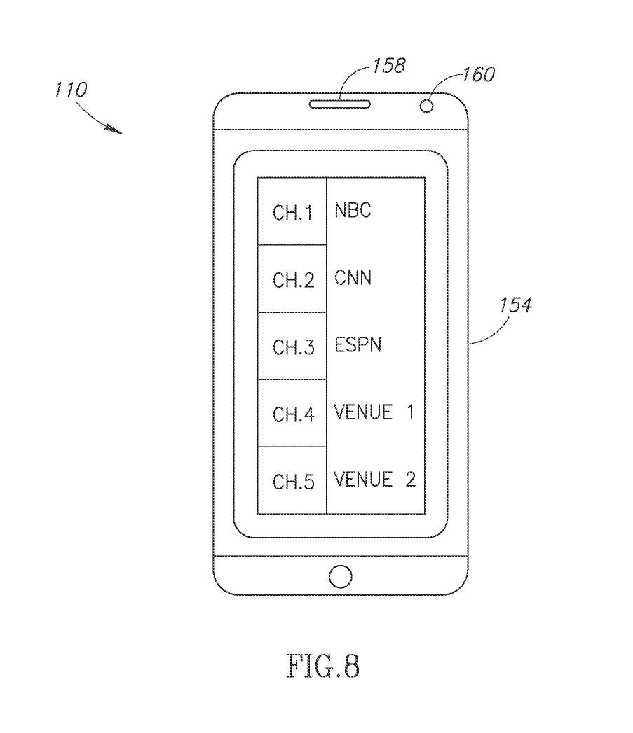

In yet another embodiment, the UE 110 can receive a plurality of channels and show the video from each of the channels as a thumbnail image, as illustrated in FIG. 8. In FIG. 8, the thumbnail video image from channels 1-5 may be shown on one portion of the display 154 and text data, such as labels, can provide the user with information related to each of the channels. The labels may include graphical information, such as logos, in addition to, or in place of, text data.

Alternatively, the thumbnail images in FIG. 8 (or the images in FIGS. 4 and/or 5) may be still images, such as frames captured from the streaming video for the respective channels. That is, the images in the thumbnail displays in FIG. 8 may be captured frames from each of the respective channels to provide the user with a graphical indication of the content of each video channel. In yet another alternative, the frame rate may be reduced in the smaller images, such as the display of FIG. 8, to reduce the overall processing task for the four CPUs 150 (see FIG. 5). In this embodiment, the CPUs will display only a portion of the video frames for each channel.

Those skilled in the art will appreciate that the multi-channel screen displays in FIGS. 4-6 will be best displayed with a reduced resolution. That is, the resolution of channel Ch. 1 in FIG. 8 is significantly lower than the resolution of channel Ch. 1 in FIG. 7 which, in turn, has a lower resolution than channel Ch. 1 in FIG. 6. Image scaling to alter the resolution is well known in the art and need not be described in greater detail herein.

In the embodiments of FIGS. 6-8, the display 154 may serve as a television guide to provide information to the user on the available channels and the content of those channels. As discussed above, the portion of the display labeled Ch. 1-Ch. 5 in FIG. 8 may contain thumbnail video images, still images, or reduced frame rate video from the respective channels. The graphical and/or text information provides greater detail to the user. In this embodiment, the user may select a single channel for a full screen display simply by touching on the appropriate portion of the display 154. For example, the user may tap on the display 154 proximate the video display for any of channels Ch. 1-Ch. 3 to view commercial television broadcasts. Alternatively, the user may tap on channel Ch. 4 or Ch. 5 to select video images from within a particular venue at which the UE 110 is present, or from a venue remote from the current location of the UE.

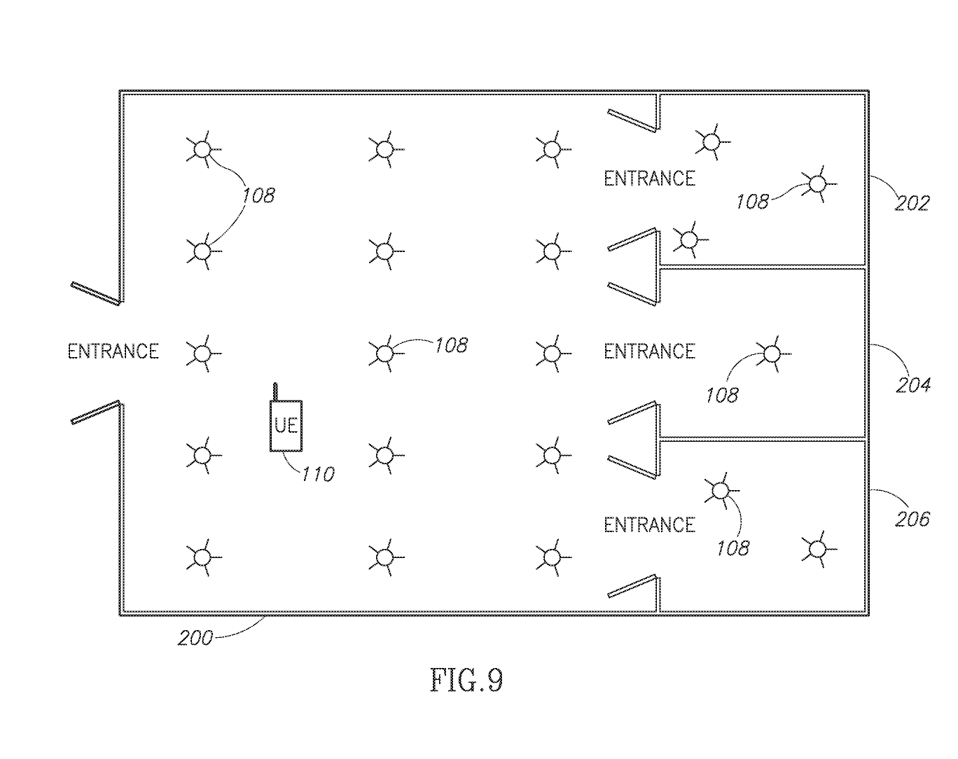

FIG. 9 illustrates a large venue 200, in which a network of APs 108 has been deployed. The position and coverage area of the APs 108 can be determined based on the particular hardware implementation. The actual distribution and installation of the APs 108 using the infrastructure 106 (see FIG. 1) within the venue 200 is within the engineering knowledge of one skilled in the art and need not be described in greater detail herein.

In the embodiment of FIG. 9, all of the APs 108 are coupled to the video server 104 in FIG. 1. As the UE 110 moves throughout the venue 200, it is making and breaking wireless communication devices with one or more of the APs 108. Thus, the UE 110 can receive a selected streaming video channel anywhere within the venue 200.

The identity of the UE 110 can be verified by the UE providing a profile and user information and signing up for the WiFi service and downloading the API. Initially this may be accomplished through a portal page, as will be described in greater detail below.

Once the identity of the UE 110 has been verified, the video server 104 can provide a selection of available video streams. For example, a selection of available video streams may be shown on the display 154, which may also be a touch-sensitive display. In a typical embodiment, illustrated in FIG. 8, there is a short description of the video stream along with the video thumbnail image shown on the display 154. The user simply taps the display 154 near the description or the video image of the desired video stream. The port number associated with the selected video stream is supplied to the CPU 1 to begin the video streaming process. In an exemplary embodiment, the CPU 1 and CPU 2 may use progressive downloading so that a short segment of the video stream is captured by the CPU 1 before the CPU 2 begins the play-out process. This allows a smoother transition to video streaming and avoids any initial buffer starvation.

The venue 200 of FIG. 9 is illustrative of a broad range of embodiments of the system 100. In one embodiment, the venue 200 may be a casino venue and the venues 202-206 are related venues, such as a performance venue 202, a nightclub venue 204, or a restaurant venue 206, all housed within the casino venue 200. In another example, the venue 200 may be a large outdoor venue, such as a music festival. In this example, the venues 202-206 may represent difference musical stages within the venue. Although FIG. 9 illustrates the venues 202-206 as adjacent to each other within the venue 200, those skilled in the art will appreciate that there is no technical requirement that these venues be physically adjacent.

In yet another example, the venue 200 may represent a film festival venue and the related venues 202-206 may represent Individual theaters participating in the film festival. Those skilled in the art will appreciate that, in this embodiment, the venue 200 may encompass a portion of a city or even the entirety of a large town, such as the Sun Dance Film Festival in Park City, Utah.

In each of these embodiments, the network of APs 108 is distributed throughout the venue so that users may monitor activities throughout the venue, For example, in the music festival scenario, the user may monitor activity at each of the stage venues 202-206 continuously. In the film festival example, users may view trailers or other information from each of the theater venues 202-206. In the casino venue example, the user can receive advertising or other data from the related venues 202-206. In addition, the casino venue may provide other video streams, such as parimutuel events (i.e., horse races), sporting events (e.g., football, baseball, basketball, etc.), instructional videos, such as rules and/or tips on playing certain games within the casino, or the like. The user simply taps the display 154 near the desired video stream and the video streaming will begin. While the UE 110 remains within the venue 200, it is in substantially continuous contact with the APs 108 and may receive data therefrom.

During a lull in activity in the video streaming, such as a timeout in the sporting event, the venue may provide its own advertising or other information to the UE 110. The ads may take the form of still images, videos similar to commercial television ads, or the like. The received videos can also have banner ads included or the video server 104 (see FIG. 1) can modify the video feeds to include advertising spliced into the video feed. This requires video processing equipment that is known in the art for this purpose. In yet another example, the video server 104 (see FIG. 1) may provide related information inserted into the video feed. For example, in the music festival venue 200, the video server 104 can provide the lyrics to songs currently being played at any of the stage venues 202-206. In this embodiment, the video server 104 can be configured to send the lyrics only to APs 108 in the vicinity of the particular stage venue. For example, all APs 108 within the venue 200 may provide video feeds from each of the stage venues 202-206. In one example, the lyrics for each of the stage venues may also be provided as part of the video feeds for each respective stage venue 202-206. Alternatively, the video server may transmit the video signals for all of the stage venues 202-206 to all APs 108 within the venue 200, but only transmit the song lyrics to the APs 108 located near each respective stage venue 202-206. In this manner, only UEs 110 proximate a particular stage venue (e.g., the stage venue 202) would receive the song lyrics. Those skilled in the art will appreciate that the lyrics may be provided as an overlay onto the video signal or shown as a form closed-captioning.

Furthermore, the heartbeat data, described above, can be used to provide a personal targeted advertising for an individual UE 110 as part of a streaming video on a particular channel. For example, in the casino venue example, the UE 110 could receive an ad for free or discounted tickets to the performance venue 202 or an invitation to happy hour at the nightclub venue 204 or a discounted meal at the restaurant venue 206. If the owner of a UE 110 is not a registered guest at a hotel within the venue 200, the APs 108 could send an invitation or ad to book a room in the venue 200. The UE 110 can communicate with the video server 104 or another server (not shown) within the venue 200 via the APs 108 to accept one or more of the ad offers. For example, the UE 110 could transmit an acceptance and book tickets at the performance venue 202. Similarly, the user of the UE 110 can book a room in the venue 200.

In the film festival venue example, the UE 110 may receive ads indicating the imminent start of a movie as the UE 110 passes by a particular theater venue (e.g., the theater venue 206). In this embodiment, advertisements may be sent only to the APs located near the particular theater venue so that the ads are more relevant to the current location of the UE 110.

In another embodiment, the venue 200 can provide channels for entertainment for special groups, such as children's television programs, children's videos, and the like.

FIG. 10 illustrates a system architecture that allows operation of the system 100 across multiple venues. As discussed above with respect to FIG. 9, the venue 200 may have a large number of APs 108 distributed throughout the venue. The various APs 108 are coupled together using the infrastructure 106. Among other things, the infrastructure allows an interconnection to a network 210 via a communication link 212. In a typical embodiment, the network 210 may be implemented as the Internet. In addition to the communication link 212, the infrastructure 106 provides a backhaul 214 to a cloud computing environment designated herein as a JUMMMP Cloud 216. The backhaul 214 may be implemented in a variety of different manners using known technology. In one embodiment, the backhaul 214 may be routed to the JUMMMP Cloud 216 via the network 210.

Within the JUMMMP Cloud 216 are a number of components. A web portal page and policy controller server 220 controls user authentication across a number of different venues in addition to the venue 200. A network management element 222 controls overall operation of the network in the JUMMMP Cloud 216 including registration and authentication services. FIG. 10 illustrates a log-in web page 224.

A local ad server 230 in the JUMMMP Cloud 216 may provide ads for the venue 200. As discussed above, the ads may be still images or streaming video and may be directed to the venue 200 itself or for the related businesses 202-206 (see FIG. 9). In addition, the ads may be for businesses near the venue 200 (or for other venues in the JUMMMP network). The centralized ad server 230 in the JUMMMP Cloud 216 simplifies the network architecture within the venue 200 and other venues by eliminating the need for an ad server within each venue.

A data base server 232 in the JUMMMP Cloud 216 may be configured to collect a broad range of information regarding the UEs 110 (including the user profile information stored in the memory 156 (see FIG. 5) of the UE that was provided when the UE was first identified in the venue. The profile information will help provide targeting marketing and advertising to the UE 110 as it traverses the venue. In addition, the profile information may be used to select the streaming videos that may be provided to the user. For example, if the user profile indicates that the owner of the UE 110 is an avid football fan, the selections of video streams may include multiple football games. In the music festival example of FIG. 9, the ads may be selected based on information provided directly by the user or derived from other sources, such as music playlist stored in the UE 110. From that playlist, it may be determined that the user has certain musical preferences and the ads can be tailored based on this information. As previously discussed, the heartbeat signal from the UE 110 may include geo-location data. The database server 232 is configured to store location information, along with time/date data to thereby track movements of the UE 110.

The UE 110 must register with the system 100 at some initial point in time. The initial registration can be performed remotely using, by way of example, a personal computer (not shown) connected to the JUMMMP Cloud 216 via the network 210. In another variation, the UE 110 can perform an initial registration as it enters the venue 200 illustrated in FIG. 10, as described above. When the UE 110 initially contacts one of the APs 108, the policy controller server 220 will not have any data related to the particular UE 110. In this case, that initial AP 108 in the venue 200 may perform an initial registration. For the initial registration, the UE 110 can connect to the initial AP 108 and provide identification information. In an exemplary embodiment, the user can complete the initial registration process by providing data, such as the telephone ID (i.e., the phone number), a device ID, a user ID, and an email address as well as other information, such as the user profile data stored in the memory 156 (see FIG. 5) of the UE 110. The user ID may be a user generated name, nickname, or the like. The device ID may vary based on the particular type of the UE 110. For example, if the UE 110 utilizes an Android™ operating system, the device can be assigned an Android™ ID. In addition, the UE 110 may typically be assigned an international mobile equipment identification (IMEI). Any of these device identifications alone may be transmitted to the registration server 222. In another alternative embodiment, a unique hash of one or more device IDs may be generated and transmitted to the registration server 222 as the device ID. The short-range transceiver 176 (see FIG. 5) may also include an identification, such as a MAC address that is unique to the UE 110. The registration data described above can be provided to the registration server 222 along with the MAC address. The registration data may be stored in association with the MAC address. Once the initial registration process has been completed, subsequent authentications are greatly simplified.

In one embodiment, a previously-registered UE 110 may come within range of the initial AP 108 in the venue 200 of FIG. 10 and establish a wireless communication link therewith. In establishing the communication link, the UE 110 automatically transmits its MAC address and/or the phone ID or IMEI. The AP 108 transmits an authentication request message to the registration server 222 to determine whether the UE 110 is a registered device. Based on the MAC address, the registration server 222 can confirm that the UE 110 has previously registered. Thus, the UE 110 is authenticated whenever it comes into range of an AP 108 of the system 100. This may occur transparently to the user. This automatic authentication process can occur even if the initial registration was in a completely different part of the country. Thus, the UE 110 may move from one venue 200 to another in the same city or region or may be in a completely different part of the country and be automatically identified and authenticated with APs 108 that are part of the system 100 described herein. This convenient registration and authentication avoids the need for constantly searching for a WiFi connection as required by other systems. Based on this automatic authentication process, the UE 110 may be automatically connected to the WiFi network created by the APs 108 in the venue 200.

The registration process at a single venue has been discussed above with respect to FIG. 10. The JUMMMP Cloud 216 also advantageously provides a centralized registration function for multiple venues, as illustrated in FIG. 11. The multiple venues 200 are each connected to the JUMMMP Cloud 216 via individual respective backhauls 214. If a UE 110 initially registers at Venue 1, using the registration process described above, that registration information is stored in the JUMMMP Cloud 416. At a later point in time when the user enters, by way of example, Venue 2 illustrated in FIG. 11, the UE 110 will automatically identify the AP 108 and begin to communicate therewith. Because the UE 110 has already been registered, that information is passed along to the JUMMMP Cloud 216 and the UE is automatically authenticated. This is true even if the various venues 200 are located far from one another. For example, an initial registration of the UE 110 may take place at a sports venue in, by way of example, New York City. However, if the UE 110 is carried to a casino in, by way of example, Las Vegas, Nev., the UE 110 will automatically begin to communicate with the AP 108 in the new venue in Las Vegas. Because each venue is coupled to the JUMMMP Cloud 216, the UE 110 need not undergo another registration process when it enters the venue 200 in Las Vegas. Thus, a single registration process at any venue is sufficient for registration with the JUMMMP Cloud 216. Whenever the UE 110 goes into a different venue 200 that is coupled to the JUMMMP Cloud 216, the UE 110 is automatically recognized and authenticated.

In another example of a business-related implementation, the venue 200 may be a sports stadium, horse track, auto race track, golf course, concert venue, festival venue, and the like. Cameras and microphones can be placed at strategic locations throughout the venue to provide the individual video streams. In these embodiments, the APs 108 are distributed throughout the venue. The UE 110 communicates with one or more of the APs 108 in the manner described above. The UE 110 can perform an initial registration process or an automatic authentication process, as described above. The APs 108 maintain virtually continuous contact with the UE 110 while it is within the sports venue 200. As discussed with respect to FIG. 10, the APs 108 are coupled to the infrastructure 106 to allow the distribution of multiple video channels to all of the UEs 110 within the sports venue 200. For example, one video channel can provide an overall view of the playing field while other video channels may provide different vantage points, such as close-up video streams of the quarterback in football, different holes on a golf course, different turns on a race track, and the like. Those skilled in the art will appreciate that a typical venue, such as a football stadium, will have a number of different cameras used by network television to provide the various vantage points described above. In conventional operation, the feeds from those cameras are routed to a control center where an individual, such as the producer, selects a view for broadcast. The centralized control center will receive all video feeds. These various video feeds may be provided to the video server 104 (see FIG. 1) for broadcast via the system 100 in the manner described above. Those skilled in the art will appreciate that other sports, such as basketball, hockey, baseball, and the like have a similar arrangement with cameras in various locations throughout the sports venue which video feeds are provided to a control center. As described above, the various video vantage points may be provided to the UE 110 for selection and viewing. In one embodiment, the system 100 can provide a list, similar to a television guide, as one of the available channels by encoding guide data in a series of data packets and providing each of those packets with a port number designated for such guide data. In this manner, the UE 110 can receive the guide data by selecting the channel number associated therewith. For example, the guide data may provide multiple channel views, as illustrated in FIG. 8, to assist the user in selecting the desired channel. The user may select which video stream to view on the UE 110 by selecting the appropriate channel. However, all of the video streams described above may be made available for selection by any of the UEs 110 within the venue 200. In addition, the JUMMMP Cloud 216 can disseminate information to the UEs 110 in the manner described above. The disseminated information may be in the form of advertisements from vendors within the venue 200, future availability of videos (e.g., upcoming sports events), and the like.

In an alternative embodiment, the video server 104 (see FIG. 1) can send command data to all APs 108 within the venue 200 or to selected APs within the venue to force the UEs 110 to change port numbers for processing by the CPU1 (see FIG. 5). This effectively causes the UE 110 to “change channels.” That is, the UE 110 receives a data command and changes the port number for the received UDP data packets. As described above, the CPU1 will identify and save all UDP data packets having a selected port number. In this instance, the initial port number is altered via a data command from the video server 104.

For example, in the venue 200, it may be possible to cause some or all of the UEs 110 to change channels and receive a commercial during a time out. After the commercial, or when the time out ends, the individual UEs 110 can automatically revert back to the original channel by reinstating the initial port number used by the CPU1. Alternatively, the UEs 110 can switch back to the initial port number upon receipt of an additional data command from the video server 104. In yet another alternative embodiment, the video server 104 may temporarily provide the same feed on all available ports numbers for a short time.

In another example embodiment, the system could be used in promotional activities. For example, a radio station can provide multiple video channels in the manner described above. There could be one or more channels directed towards the disk jockey and guests, and additional channels to provide videos associated with music. In this example, the video streams can be a combination of live video feeds generated at the radio station as well as local video feeds from data storage, remote video feeds from a network feed or the like. The UE can access the stream of video data packets via a website associated with the radio station or by accessing the website of a content provider or Internet service provider.

In addition to the video streams, the radio station can provide promotions and advertising. As discussed above, the ads can be videos, banner ads, still images and the like. For example, the radio station can offer free tickets, discounts, free merchandise from the radio station, musical guests, featured acts, and the like. The ads can also provide a mechanism for musicians to advertise their music, merchandise, concert dates, tickets, and the like.

As discussed above, an API executing on the UE 110, provides a heartbeat signal. The heartbeat signal can provide identification data, location data, user-preference data, and the like. The heartbeat signal can be used to provide targeted ads for users. In addition, the radio station can push data, such as playlists, etc., to users through the API or an APP executing on the UE 110.

The previous discussion has focused on distribution of video streams throughout a local venue. However, those skilled in the art will appreciate that the video streams can also be transmitted to remote locations via the network 210, such as the Internet. FIG. 12 illustrates an example system architecture for the delivery of streaming media data to remote locations. Prior to transmission on the network 210, the multiple video streams are combined into a single stream of video data packets, with the packets corresponding to each respective video stream having a designated different port number. This process is described above with respect to FIG. 1. As illustrated in FIG. 1, the video server 104 provides the single stream of video data packets to the infrastructure 106, such as routers and switches. As discussed, the infrastructure 106 may also provide a pathway to a gateway. Returning to FIG. 12, the video server 104 is coupled to the network 210 via a network interface controller (NIC) 232. The NIC 232 is a conventional component that may be implemented in a variety of fashions depending on the available interface from the video server 104 and the manner of connectivity to the network 210. For example, the video server 104 may provide an Ethernet interface to the NIC 232. In turn, the NIC 232 may be coupled to the network 210 via a wireless connection, cable connection, optical connection, or the like. The NIC 232 may also be coupled to an intermediary network service provider (not shown) to gain access to the network 210.

At a remote location, a receiver 234 is also coupled to the network 210 via an NIC 236. As discussed above with respect to the NIC 232, the NIC 236 may take a variety of forms depending on the particular implementation details. The NIC 236 may be coupled to the network 210 via a network service provider (not shown).

The receiver 234 may be a conventional computer, such as a desktop, laptop, tablet computer, or similar computing device. The receiver 234 may also be implemented as a conventional wireless communication device, such as the UE 110 (see FIG. 1). As those skilled in the art will appreciate, many modern television sets provide direct computer interfaces for Internet connectivity. In this embodiment, the receiver 234 and NIC 236 may be integrated into a single device, such as a widescreen television.

A display 238 and audio system (not shown) are coupled to the receiver 234. If implemented as a television, as described above, or a UE 110, the receiver and display functionality may be integrated into a single device.

In operation, the receiver 234 may have controls operable by a user to select a particular channel for reviewing, similar to the process described above with respect to FIG. 8. That is, the receiver 234 can effectively select a port number by choosing a channel for viewing. Alternatively, the receiver 234 can select multiple channels and provide a split screen display on the display 238. The decoding operation for the selected port number has been described above. Thus, a remote user can have the same channel selectivity as a user located at the venue.

In an alternative embodiment, also illustrated in FIG. 12, the NIC 236 may be coupled to infrastructure 106, such as routers and switches to thereby distribute the stream of video data packets to one or more APs 108 as part of a local area network (LAN). In turn, the receiver 234 may be coupled wirelessly to the NIC 236 via an AP 108.

In an exemplary embodiment, a user may be required to pay for remote delivery of the streaming video channels. In one embodiment, access to the streaming video may be provided as a “premium service” if the user subscribes to a network service provider. In this embodiment, the user may pay a flat monthly fee to the network service provider for access to the premium channels. Alternatively, requests for specific programs may be requested using “on-demand” or “pay-per-view” services. In an on-demand scenario, the network service provider may bill the user directly at the end of the month for each event accessed by the user. In a pay-per-view scenario, the user may be requested to provide a credit card to pay for access to the streaming video data packets.

In any of these embodiments, billing may be handled by a network service provider. In this case, the network service provider can provide or deny access to the stream of video data packets. Conventional encryptment techniques may be used to prevent unauthorized access. Alternatively, access control may be implemented at the video server 104 in FIG. 12.

FIG. 13 is a flowchart illustrating operation of the process of FIG. 12. At a start 250, a venue is provided with multiple video sources, such as cameras distributed throughout the venue. In step 252, the video server 104 combines the various video data streams into a single stream of video data packets wherein each data packet is assigned a port number based on the identification of the original data stream. Thus, each video input stream provided to the video server is assigned a unique port number and the video data packets from that data stream are assigned that corresponding port number.

In optional step 254, a user billing process is implemented. As discussed above, the billing process may be handled by a network service provider or directly from the venue. Following the optional billing process, the receiver authentication is confirmed in step 256.

In step 258, the video server 104 transmits the single stream of video data packets onto the network 210 via the NIC 232. The receiver 234 functions in the manner described above to receive and decode the selected video streams. The process ends at 260. Thus, a venue can provide multiple video channels that can be selected by users at the venue or even in locations remote from the venue.

Although several example venues and applications have been discussed herein, those skilled in the art will appreciate that the system is not limited to these examples. Thus, the system described herein enables the delivery of a large number of video streams via a network of APs and allows each UE to select which channel to view.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A method for the transmission of a plurality of video streams sent from a sending device to a receiving device, comprising:
receiving a plurality of video streams;
converting the plurality of video streams to a single stream of video data packets with each of a plurality of video data packets for a respective one of the video streams being assigned a port number corresponding to the respective video stream; and
the sending device transmitting the stream of video data packets on a computer network.

2. The method of claim 1, further comprising the sending system confirming authentication of the receiving system as a subscriber authorized to receive the single stream of video data packets.

3. The method of claim 1, further comprising the sending system receiving confirmation of user payment for authorization to receive the single stream of video data packets.

4. The method of claim 1 wherein the sending device transmits the stream of video data packets on a wide-area computer network, the method further comprising:
the receiving system communicatively coupled to the wide-area computer network and selecting a port number corresponding to a selected one of the plurality of video streams;
receiving ones of the stream of video data packets having the selected port number; and
routing the received video data packets to a local area network for further distribution.

5. The method of claim 4 wherein the local area network comprises at least one wireless access point (AP), the method further comprising the at least one AP transmitting received video data packets to a wireless communication device for display on the wireless communication device.

6. The method of claim 5, further comprising:
the receiving system communicatively coupled to the at least one AP and selecting a port number corresponding to a selected one of the plurality of video streams;
receiving ones of the stream of video data packets having the selected port number; and
displaying the selected received stream of video data packets on a display of the receiving system.

7. The method of claim 1, further comprising:
the receiving system communicatively coupled to the computer network and selecting a port number corresponding to a selected one of the plurality of video streams;
receiving ones of the stream of video data packets having the selected port number; and
displaying the selected received stream of video data packets on a display of the receiving system.

8. The method of claim 7, further comprising the receiving system altering the selected port number, receiving ones of the stream of video data packets having the altered port number, and displaying the received stream of video data packets having the altered port number on a display of the receiving system.

9. The method of claim 7 wherein the receiving system processes only data packets having the selected port number.

10. The method of claim 7, further comprising the receiving system selecting a plurality of port numbers corresponding to selected ones of the plurality of video streams and receiving data packets having the selected port numbers.

11. The method of claim 10, further comprising the receiving system displaying the selected ones of the plurality of data streams on separate portions of the display of the receiving system.

12. The method of claim 1 wherein a first one of the plurality of video streams is generated at a radio station.

13. The method of claim 12 wherein at least one of the plurality of video streams comprises an advertisement.

14. The method of claim 12 wherein at least one of the plurality of video streams comprises promotional information.

15. The method of claim 12, further comprising receiving user information from the receiving device wherein at least one of the plurality of video streams comprises promotional information based at least in part on the received user information.

16. The method of claim 1 wherein a first one of the plurality of video streams is a live video stream generated at a radio station and a second of the plurality of video streams is a stored video stream.

17. A method for the reception and processing of a stream of video data packets sent from a sending device to a receiving device on a computer network, comprising:
coupling the receiving system to the computer network;
receiving the stream of video data packets, each video data packet of the stream of video data packets being assigned a port number corresponding to respective ones of a plurality of video streams;
selecting a port number corresponding to a selected one of the plurality of video streams;
receiving ones of the stream of video data packets having the selected port number; and
displaying the selected received stream of video data packets on a display of the receiving system.

18. The method of claim 17, further comprising the receiving system altering the selected port number, receiving ones of the stream of video data packets having the altered port number, and displaying the received stream of video data packets having the altered port number on a display of the receiving system.

19. The method of claim 17, further comprising the receiving system selecting a plurality of port numbers corresponding to selected ones of the plurality of video streams and receiving data packets having the selected port numbers.

20. The method of claim 19, further comprising the receiving system displaying the selected ones of the plurality of data streams on separate portions of the display of the receiving system.

21. A system for the transmission of a plurality of video streams, comprising:
a video processor configured to receive a plurality of video streams from different video sources and to convert the plurality of video streams to a single stream of video data packets with each of a plurality of video data packets for a respective one of the video streams being assigned a port number corresponding to the respective video stream;
a sending device coupled to a computer network and configured to transmit the stream of video data packets on the computer network;
a receiving system communicatively coupled to the computer network and configured to select a port number corresponding to a selected one of the plurality of video streams, the receiving system being further configured to receive ones of the stream of video data packets having the selected port number; and
a display on the receiving system to display the selected received stream of video data packets.

22. The system of claim 21, further comprising an authentication processor associated with the sending system and configured to confirm authentication of the receiving system as a subscriber authorized to receive the single stream of video data packets.

23. The system of claim 21, further comprising an authentication processor associated with the sending system and configured to confirm user payment for authorization to receive the single stream of video data packets.

24. The system of claim 21 wherein the receiving system is further configured to alter the selected port number to thereby receive ones of the stream of video data packets having the altered port number, and display the received stream of video data packets having the altered port number on the display of the receiving system.

25. The system of claim 21 wherein the receiving system is further configured to select a plurality of port numbers corresponding to selected ones of the plurality of video streams and to receive the data packets having the selected port numbers.

26. The system of claim 25 wherein the receiving system is configured to display the selected ones of the plurality of data streams on separate portions of the display of the receiving system.

27. The system of claim 21 wherein a first one of the plurality of video streams is generated at a radio station.

28. The system of claim 27 wherein at least one of the plurality of video streams comprises an advertisement.

29. The system of claim 27 wherein at least one of the plurality of video streams comprises promotional information.

30. The system of claim 27, further comprising receiving user information from the receiving device wherein at least one of the plurality of video streams received by the video processor comprises promotional information based at least in part on the received user information.

31. The system of claim 21, further comprising a data storage device wherein a first one of the plurality of video streams is a live video stream generated at a radio station and a second of the plurality of video streams is a stored video stream stored in the data storage device.
